(19) United States
(12) Patent Application Publication
(10) Pub. No.: US 2015/0226889 A1
(43) Pub. Date: Aug. 13, 2015

(54) DECORATIVE GLASS PANEL HAVING A REFLECTIVE LAYER DEPOSITED ON A TEXTURED SUBSTRATE

(71) Applicant: SAINT-GOBAIN GLASS FRANCE, Courbevoie (FR)

(72) Inventors: François Guillemot, Paris (FR); Nicolas Chemin, Bagneux (FR)

(73) Assignee: SAINT-GOBAIN GLASS FRANCE, Courbevoie (FR)

(21) Appl. No.: 14/426,768

(22) PCT Filed: Sep. 10, 2013
(86) PCT No.: PCT/FR2013/052071

§ 371 Date: Mar. 9, 2015

(30) Foreign Application Priority Data
Sep. 10, 2012 (FR) 1258459

(51) Int. Cl. G02B 5/08

(52) U.S. Cl. CPC G02B 5/0808

(57) ABSTRACT

A composite successively includes a transparent substrate, and a transparent layer, a portion at least of the surface of which is textured, with characteristic dimensions of the texturing forms of between 10 nm and 100 μm, and coated with a reflective layer.

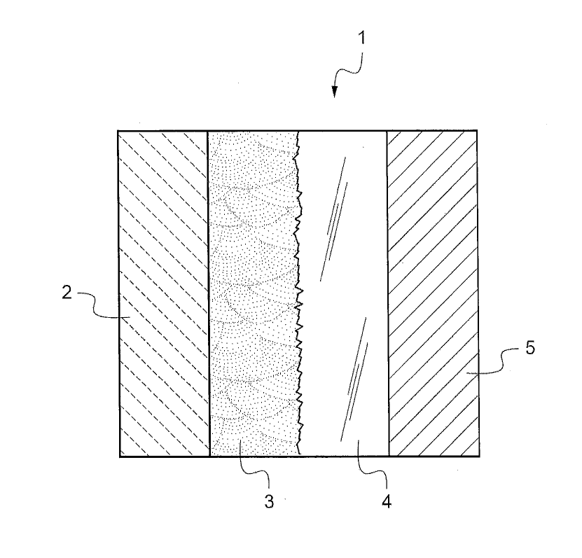

The present invention relates to a decorative glazing, a portion at least of the surface of which is textured and directly coated with a reflective layer.

The object of the invention is to make available decorated interior/exterior fitting elements exhibiting a first exterior (front) face which is smooth and easily cleanable but has a low scratchability (sheet of glass or equivalent) and a second (back) face exhibiting a texture of chosen geometry and provided with a reflective coating, which produce a decorative appearance visible on the side of the first face of these fitting elements. They can be sheets or panes of glass or plastic or be an elaborated clear glass-ceramic plate which can be used in interior and exterior fittings (kitchen sideboard, furniture, and the like), domestic electrical appliances, and the like.

Until now, texture/reflective layer pairs have been limited by the scales and the forms of textures easily available, that is to say by the texturing process. For those obtained by hot rolling, the scales are greater than a few hundred microns and, for satin finish glass, the form and scale of the textures (period 150 μm) are fixed by the mechanism of chemical attack on the glass (for example, 10 μm in height according to the duration of attack).

The inventors set themselves the aim of producing composites made of sheets, the surfaces of which can be of relatively large, unlimited, dimensions, of the order of a square meter and more, an external surface of which is composed of a sheet of glass or equivalent and the appearance of which is given by a texture of 10 nm to 100 μm which is perfectly controllable over a portion at least of the surface of the composites, and covered with a reflective layer. When the latter is a metallization, the controllable and also reproducible texture makes it possible to give the glazing an appearance as complex as those of stainless steel or brushed or rubbed aluminum. Thus, tables or other items of furniture, wall covering tiles, and the like, having decorative effects are produced.

This aim was achieved by the invention, which consequently has, as subject matter, a composite successively comprising:
a transparent substrate,
a transparent layer, a portion at least of the surface of which is textured, with characteristic dimensions of the texturing forms of between 10 nm and 100 μm, and coated with a reflective layer.

The invention thus makes use of the most recent techniques for the formation of a texturing form on a deformable layer, which will be discussed in more detail subsequently, and which make it possible to form patterns in relief having perfectly defined forms and dimensions as small as 10 nm and more. The textured surface of the transparent layer is thus, as desired, ordered or nonordered, or else the perfect duplication of any “mother surface”, of whatever material. On looking from the side of the transparent substrate opposite said transparent layer, the appearance of a surface of this material, or any desired decorative effect, is thus observed.

According to other preferred characteristics of the composite of the invention:
the characteristic dimensions of the texturing forms are at most equal to 30 μm, and
by increasing order of preference, at least equal to 50, 100 and 500 nm; stainless steel and brushed or rubbed aluminum can, for example, be described by patterns with a depth of 1 to 2 μm and with a pitch of 10 to 20 μm;
the transparent substrate is chosen from a glass material (soda-lime float glass, which is optionally tempered, borosilicate glass, and the like), a glass-ceramic, in particular a clear one, and a (transparent) polymer material, such as polycarbonate, polymethyl (meth)acrylate, polystyrene, poly(vinyl chloride), polyamide, polyethylene or polypropylene, alone or as blends or copolymers of several of them, ionomer resin, and the like; when a polymer material is concerned, it can be provided, on its face opposite said transparent layer, with a scratch-resistant coating, such as made of polysiloxane or equivalent;
the textured layer is made of a thermally crosslinkable material, in particular a sol-gel material, exhibiting the advantage of resulting in layers having a high inorganic content which can withstand a process for tempering a glass sheet (constituting the substrate); mention may be made of silica, titanium oxide, zinc oxide or aluminum oxide, alone or as a mixture of several of them; a silica sol is advantageously obtained by hydrolysis of a sol-gel precursor, preferably methylethoxysilane; it is important to control the conditions for preparation of the sol-gel solution so that the layer remains deformable during the process;
the textured layer is made of a material which can crosslink under UV radiation;
the textured layer has a thermoplastic polymer matrix; mention may be made of poly(methyl methacrylate), polystyrene, polycarbonate, polyvinyl chloride), polyamide, polyethylene or polypropylene, alone or as blends or copolymers of several of them;
the reflective layer
   is opaque or
   transparent;
   comprises a metal, such as silver or aluminum, and/or an oxide having a high index, such as TiO₂ or ZrO₂, and/or a paint; in a realization in accordance with the invention, the reflective layer can be a plastic film textured, metalized or painted on one face and provided with an adhesive layer on the other face, for the adhesion to the transparent substrate;
   has a real refractive index at the wavelength of 600 nm at least equal to 1.8;
the reflective layer is covered with a protective layer; the latter can also be opaque or transparent and consists, for example, of an organic and/or inorganic paint;
a portion of the surface of said transparent layer is not textured and coated with a reflective layer; in this alternative form, the mirror function thus coexists with the decorative function which is the subject matter of the invention.

The composite described above can be manufactured according to several processes.

A first process comprises
the deposition of a deformable layer—precursor of said transparent layer, a portion at least of the surface of which is textured—on a transparent substrate,
the bringing of this deformable layer into contact with the textured face of a secondary stamp,
the introduction of the coated substrate and of the secondary stamp into a bag made of nonpermeable material,
the introduction of the bag and of its contents into a sealed chamber,
the evacuation of the air from the chamber down to a pressure at most equal to 0.5 bar,
the sealing of the bag before reintroduction of the air into the chamber,
the introduction of the sealed bag and its contents into an autoclave,
the application of a pressure between 0.5 and 8 bar and of a temperature of between 25 and 400° C. for 15 minutes to several hours,
the opening of the bag, then
the separating of the substrate and the secondary stamp.

The texturing form formed according to this process has dimensions of between 10 nm and 100 μm (depth of the valleys, height of the protuberances, width/diameter of the protuberances, width of the valleys, and the like), indeed even up to values of several centimeters: “wall” of 10 μm×10 μm×4 cm.

The texturing form is capable of being formed, by this process, on surfaces of the order of a square meter at least, up to the dimensions of the “Full Width Float (FWF)” glass sheet, that is to say 3 m×6 m in particular.

The processes for the deposition of the deformable layer on the transparent substrate are not limited. Deposition by the liquid route (laminar flow coating, spray coating, dip coating and spin coating) is employed. In laminar flow coating, the liquid precursors of the deformable layer form, at rest, a meniscus suspended from a slot, from which they are removed by displacement of this slot into the transverse position above the substrate.

The secondary stamp is thus called as it results from the molding of its material with respect to a master. Its textured material can be a polymer.

The material of the bag is impermeable to air.

The air of the chamber is evacuated down to a pressure at most equal to 0.5 bar or, by order of increasing preference, to 5 mbar, 2 mbar and 1 mbar. For example, the air of the chamber is evacuated for 15 minutes until a pressure of the order of 0.5 mbar is achieved. The bag is hermetically sealed before reintroducing air into the chamber.

The sealed bag is subsequently placed in an autoclave which will make it possible to apply a pressure of between 0.5 and 8 bar and a temperature of between 25 and 400° C. The treatment in the autoclave can be between 15 minutes and several hours. These parameters have to be adjusted as a function of the nature of the deformable layer. The objective is here to press the secondary stamp against the initially deformable layer, sol-gel or other, while crosslinking it in order to render it nondeformable. In this way, the pattern inscribed at the surface of the secondary stamp is printed and petrified in the layer deposited at the surface of the substrate. The stage of sealing and evacuation of the air is necessary in order to make possible the transmission of the pressure from the fluid to the stamp.

At the outlet of the autoclave, the bag is pierced prior to being opened and the secondary stamp is withdrawn from the surface of the substrate. The layer can then be subjected to a new heat treatment in order to densify it, to crystallize it (TiO₂, ZnO) and to improve its mechanical properties and/or in order to vary the hydrophilic/hydrophobic nature of its surface.

This process does not require a specific apparatus (a system for placing under a bag and an autoclave). It is compatible with the devices commonly used in the glass industry, in particular for the lamination of windshields or also for the manufacture of an industrial glazing, such as a laminated glazing incorporating a liquid crystal film, of the type sold by Saint-Gobain Glass under the registered trade name Privalite®.

Insofar as the process involves only items of equipment already deployed on industrial lines, this process appears to be easy to operate industrially and to be compatible with the treatment of large-sized glazings.

This process is compatible with the use of low cost stamps, such as textured polymer sheets (produced by the roll-to-roll technique in particular). Insofar as the stamp is not destroyed during the process, it can be reused several times.

The textured face of the secondary stamp is advantageously permeable to air. The contacting operation during the sealing stage then does not require specific precautions to prevent the trapping of air bubbles between the coated substrate and the stamp. The latter can be composed of an elastomeric polymer (PDMS, EVA, epoxy type) or glassy polymer or of a copolymer.

In a preferred alternative form of this process, the textured face of the secondary stamp is made of a polymer or hybrid organic (polymer)/inorganic material and the temperature in the autoclave is successively brought to a temperature greater than and then lower than the glass transition temperature of this polymer material, or vice versa; this arrangement makes it possible to precisely control the mechanical behavior of the stamp and to optimize the contact between the stamp and the coated substrate and also the quality of the replication of the structures.

According to a second process, the transparent layer is textured by the use of a rotating component, as described in the document FR 2 893 610 (for example, according to a roll to plate process).

The formation on the textured (transparent) layer of the reflective layer is preferably carried out by the liquid or cathode sputtering route.

The invention is illustrated by the following implementational example, with reference to the single appended drawing, diagrammatically representing a composite according to the invention.

### EXAMPLE

The duplication of a rubbed aluminum surface in a layer of sol-gel silica is described. This texture is defined by a depth of 1-2 μm and a pitch of 10-20 μm.

A silica sol is prepared from a methyltriethoxysilane (sold by Sigma-Aldrich)/acetic acid (Prolabo) mixture according to a 45/55 ratio by weight. The solution is left stirring at ambient temperature for 12 h.

A PDMS stamp is produced by molding starting from a rubbed aluminum surface described above. The molding is carried out by casting a 10:1 mixture of the two components (elastomer: catalyst) of the Sylgard® 184 Silicone Elastomer Kit sold by Dow Corning, the residual air bubbles being evacuated under vacuum, and by then crosslinking the elastomer at 80° C. for 4 h.

The sol is deposited by spin coating (2000 rpm, 1 min) on a 2 mm glass substrate of 10×10 cm², sold by Saint-Gobain Glass under the registered trademark Planilux®, the surface of which has been cleaned beforehand by Cerox® polishing. The layer is dried at 50° C. for 5 minutes.

Subsequent to the deposition, the textured face of the PDMS stamp is brought into contact with the layer of sol-gel silica. So as to evacuate these air bubbles, which risk compromising the contact between the layer and the mask, the samples are placed in a sealing bag and placed in a sealed chamber which is evacuated until a vacuum at 0.5 mbar is achieved. At the end of the 20 minutes, the bag is sealed by thermal bonding.

The samples are subsequently placed in the autoclave, in which they are subjected simultaneously to a rise in temperature up to 110° C. and in pressure up to 1.75 bar (5 min at 20° C., rise to 60° C. over 5 min, stationary phase at 60° C. for 10 min, rise to 110° C. over 5 min, stationary phase at 110° C. for 20 min and descent to 35° C. over 15 min; rise from 0 to 1.75 bar over 5 min, stationary phase at 1.75 bar for 40 min, descent to 0 bar over 15 min). On exiting from the autoclave, the samples are removed from the molds under cold conditions.

The transfer of the pattern into the layer of sol-gel silica is characterized by AFM. The patterns obtained are similar to those carried by the stamp.

By this process, the same duplication can be carried out in a thermoplastic layer, such as poly(methyl methacrylate), or a hybrid thermoplastic-inorganic layer, such as poly(methyl methacrylate)-SiO₂.

Two types of reflective layers are deposited on glass samples provided with their textured silica layer which are thus formed.

A first type of reflective layer is a silver layer deposited according to the following procedure:
protection of the nontextured face with an acid-resistant adhesive film;
dilution of the silvering solutions (dilutable solutions provided by Dr.-Ing. Schmitt GmbH, Dieselstr. 16, 64807 Dieburg/Germany) according to:
   42 μl of Miraflex® 1200 in a 250 cm³ flask (sol. No. 1)
   125 μl of Miraflex® PD in a 250 cm³ flask (sol. No. 2)
   6 ml of Miraflex® RV in a 250 cm³ flask (sol. No. 3)
   6 ml of Miraflex® S in a 250 cm³ flask (sol. No. 4);
placing a glass substrate in a tank into which the contents of solution No. 1 are poured (directly onto the glass) (comprises Sn²⁺ and Sn⁴⁺ ions);
stirring for 1 min and then rinsing with distilled water;
placing the glass substrate in a second tank into which the contents of solution No. 2 are poured (directly onto the glass) (comprises Pd²⁺ ions);
stirring for 1 min and then rinsing with distilled water;
placing the glass substrate in a final tank into which the contents of solutions No. 3 and 4 (after starting the stopwatch) are poured (not directly onto the glass) (comprises silver nitrate and a reducing agent);
stirring for 30 seconds and then rinsing with distilled water;
placing the glass substrate in the first tank and stirring for 1 min;
rinsing with distilled water.

The silver layer thus produced has an approximate thickness of 80 nm.

A second type of reflective layer is a TiO₂ layer deposited, like the silver layer, on the textured silica surface by magnetron cathode sputtering with a TiO₂ target, a 30% Ar/(Ar+O₂) gas mixture and a deposition pressure of 2×10⁻³ mbar.

The silver or TiO₂ layer is subsequently covered with a layer with a thickness of approximately 50 μm of paint of the alkyd type having a Fenzi brand, applied by spraying, followed by baking for 15 minutes at 180° C.

With reference to the single appended figure, a composite 1, successively composed of the glass sheet 2, the textured silica layer 3, the reflective layer 4 and the protective layer 5, was thus obtained. From the side of the free face of the glass sheet 2, the rubbed aluminum texture of the textured silica layer 3—reflective layer 4 pair is observed. Any texture, any corresponding decorative appearance, can be obtained according to the invention.

1. A composite successively comprising:
a transparent substrate, and
a transparent layer, a portion at least of a surface of which is textured, with characteristic dimensions of texturing forms of between 10 nm and 100 μm, and coated with a reflective layer.

2. The composite as claimed in claim 1, wherein the characteristic dimensions of the texturing forms are at most equal to 30 μm.

3. The composite as claimed in claim 1, wherein the characteristic dimensions of the texturing forms are at least equal to 50 nm.

4. The composite as claimed in claim 1, wherein the characteristic dimensions of the texturing forms are at least equal to 100 nm.

5. The composite as claimed in claim 1, wherein the characteristic dimensions of the texturing forms are at least equal to 500 nm.

6. The composite as claimed in claim 1, wherein the transparent substrate is chosen from a glass material, a glass-ceramic and a polymer material.

7. The composite as claimed in claim 1, wherein the transparent layer is made of a thermally crosslinkable material.

8. The composite as claimed in claim 1, wherein the transparent layer is made of a material which is crosslinkable under UV radiation.

9. The composite as claimed in claim 1, wherein the transparent layer has a thermoplastic polymer matrix.

10. The composite as claimed in claim 1, wherein the reflective layer is opaque.

11. The composite as claimed in claim 1, wherein the reflective layer is transparent.

12. The composite as claimed in claim 1, wherein the reflective layer comprises a metal and/or an oxide having a high index and/or a paint.

13. The composite as claimed in claim 1, wherein the reflective layer has a real refractive index at the wavelength of 600 nm at least equal to 1.8.

14. The composite as claimed in claim 1, wherein the reflective layer is covered with a protective layer.

15. The composite as claimed in claim 1, wherein a portion of the surface of said transparent layer is not textured and coated with a reflective layer.

16. The composite as claimed in claim 12, wherein the metal is silver or aluminum.

17. The composite as claimed in claim 12, wherein the oxide is TiO₂ or ZrO₂.
